(19) United States
(12) Patent Application Publication
(10) Pub. No.: US 2014/0149945 A1
(43) Pub. Date: May 29, 2014

(54) ELECTRONIC DEVICE AND METHOD FOR ZOOMING IN IMAGE

(71) Applicant: EGALAX_EMPIA TECHNOLOGY INC., Taipei City (TW)

(72) Inventor: SHUN-LUNG HO, TAIPEI CITY (TW)

(73) Assignee: EGALAX_EMPIA TECHNOLOGY INC., Taipei City (TW)

(21) Appl. No.: 14/091,563

(22) Filed: Nov. 27, 2013

(30) Foreign Application Priority Data
Nov. 29, 2012 (TW) 101144622

(51) Int. Cl. G06F 3/0484; G06F 3/0481

(52) U.S. Cl. CPC G06F 3/04845; G06F 3/04817
USPC 715/856

(57) ABSTRACT

An electronic device and method for zooming in image are provided. The electronic device includes a touch screen and a processer. At first, the processer recognizes an object closing or touching the touch screen so as to generate a pointer at the touch screen. Then the touch screen zooms in the image within a predetermined range based on the pointer when the processer recognizes another object adjacent to the before-mentioned object.

### CROSS REFERENCE TO RELATED APPLICATIONS

This patent application claims the benefit of Taiwan Application Serial No. 101144622, filed on Nov. 29, 2012, which is herein incorporated by reference for all intents and purposes.

### BACKGROUND OF THE INVENTION

1. Field of the Invention

The present invention relates to electronic device and method for zooming in image.

2. Description of the Prior Art

With the rapid progress of science and technology, electronic products, such as the tablet PC and the cell phone which are light, thin, small, and portable, have been developed to provide much convenience to people and improve the life quality. Most of the electronic products are equipped with an input device for inputting information, for example, a mouse or a keyboard, but such input devices are not thin and simplicity. As the result, new generation of input devices, such as a touch panel, are provided and have been applied to various electronic devices. In a touch panel, there is provided with a touching region that corresponds to a displaying region, so that a user can control the electronic products by sliding or touching icons that is displayed on the touch panel to execute the corresponding function.

The size of touch panel of an electronic product is always limited, and therefore it is inconvenient to show all icons of the touch panel.

Accordingly, an electronic device and method for zooming in image are provided to avoid the kind of inconvenient.

### SUMMARY OF THE INVENTION

In accordance with an embodiment of the present invention, the present invention provides an electronic device for zooming in image, comprising: a touch screen, displaying an image and zooming in a partial image, which is the image placed partially within a predetermined range around a pointer; and a processor, identifying the proximity or the touch of an object to generate the pointer on the touch screen, and controlling that the touch screen displays the partial image while identifying another one object approaching the object.

In accordance with another embodiment of the present invention, the present invention provides a method for zooming in image, comprising: identifying the proximity or the touch of an object on a touch screen to generate an pointer on the touch screen; and zooming in a partial image, which is an image placed partially within a predetermined range around the pointer, after identifying another object approaching the object.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

FIGS. 1 to 6 are schematic diagrams of an electronic device for zooming in image according to embodiments of the present invention; and

FIG. 7 is a flowchart of a method for zooming in image according to one embodiment of the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

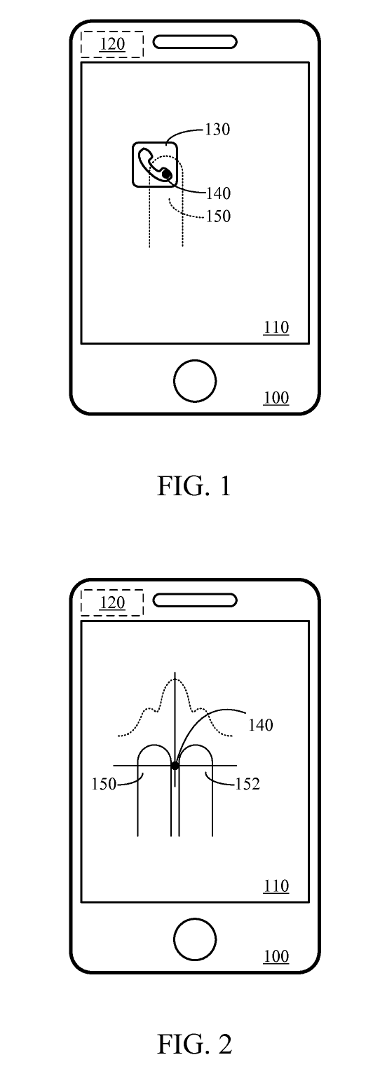

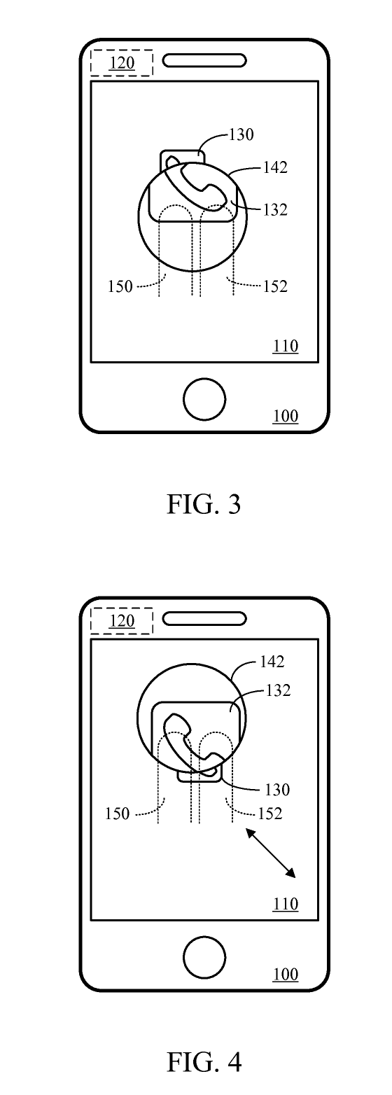

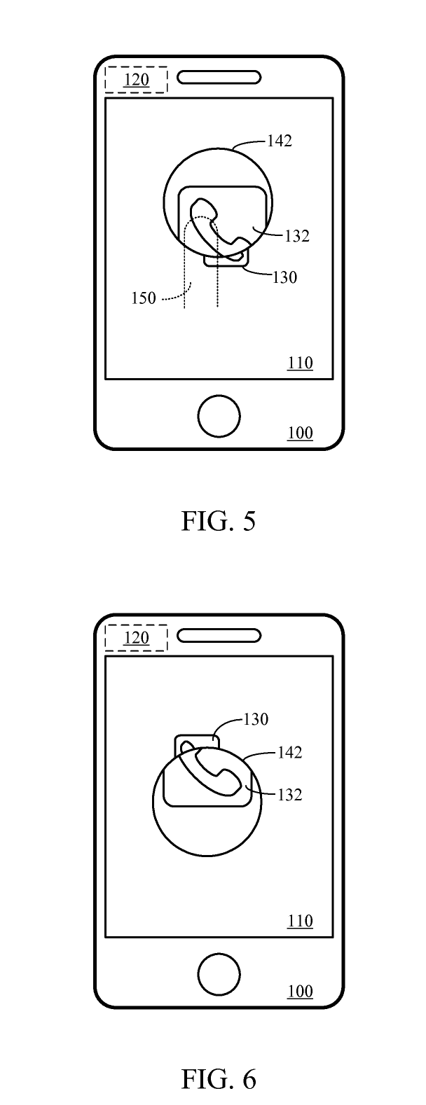

Please refer to FIG. 1, the present invention discloses an electronic device 100 for zooming in image, including a touch screen 110 and a processor 120, wherein the touch screen 110 displays an image. The processor 120 identifies the proximity or the touch of an object 150 to generate the pointer 140 on the touch screen 110. When single object 150 touch the touch screen 110 so as to generate a touch signal, the pointer 140 is placed at the position of the wave crest of the touch signal, but it is unnecessary to display the pointer 140 on the touch screen 110 (as shown in FIG. 3, FIG, 4 and FIG. 5).

Please refer to FIG. 2, while another one object 152 approaches the previous object 150, and the adjacent two objects 150, 152 touch the touch screen together to generate a touch signal, the pointer 140 is still placed at the position of the wave crest of the touch signal. It is unnecessary to display the pointer 140 on the touch screen 110 (as shown in FIG. 3, FIG, 4 and FIG. 5).

Please refer to FIG. 3, when the processor 120 identifies the another one object 152 approaching the object 150, the processor 120 controls that the touch screen 110 zooms in a partial image 132, which is the image 130 placed partially within a predetermined range 142 around the pointer 140. In other words, the processor 120 identifies the proximity or the touch of the object 150 to generate the pointer 140 on the touch screen 110. Then, the processor 120 controls the touch screen 110 to zoom in the partial image 132 while identifying the another one object 152 approaching the object 150. The pointer 140 is located at the center of the predetermined range 142, and the circumference of the predetermined range is formed by a predetermined radius.

Please refer to FIG. 3 again, when the adjacent two objects 150, 152 touch or the object (one of the adjacent two objects 150, 152) touches the partial image 132 on the touch screen 110 to generate a touch signal after the partial image 132 appears, the processor 120 generates a command of clicking on a clicked position (such as the position of the pointer 140 as shown in FIG. 1) on the partial image 132, wherein the clicked position on the partial image 132 is mapping to a position on the image 130 partially within the predetermined range 142. For example, when the pointer 140 is located at a scroll bar of a window, and the partial image 132 is generated, the partial image 132 is the partial scrollbar of the window. When the adjacent two objects 150, 152 touch or one of the adjacent two objects 150, 152 touches the position of scrolling down the window on the partially magnifying image to generate a touch signal, the processor generates a command of clicking on the clicked position (the command of scrolling down the window), wherein the actually clicked position of the touch screen 110 is a position of the real image 130, which is partially within the predetermined range 142, mapping to the position of the pointer 140 on the partially magnifying image of the scrollbar of the window.

Furthermore, please refer to FIG. 3, when the adjacent two objects 150, 152 touch or the object (one of the adjacent two objects 150, 152) touches the partial image 132 on the touch screen 110 to generate a touch signal after the partial image 132 appears, the processor 120 generates a command of clicking on a clicked icon on the partial image 132, wherein the clicked icon on the partial image 132 is mapping to an icon on the image 130 partially within the predetermined range 142. For example, when the pointer 140 is located at a dialing icon (upper section of the image 130 or the lower section of the image 130), and the partial image 132 is generated simultaneously, the partial image 132 is the dialing icon. When the adjacent two objects 150, 152 touch or one of the adjacent two objects 150, 152 touches the dialing icon on the partially magnifying image to generate a touch signal, the processor 120 generates a command of clicking on the clicked icon (the command of dialing), wherein the actually clicked icon of the touch screen 110 is the real dialing icon, which is partially within the predetermined range 142, mapping to the partially magnifying image of dialing icon.

Please refer to FIG. 3 and FIG. 4, when the pointer 140 (or the objects 150, 152) is moving, the predetermined range 142 is moving with the pointer 140 to simultaneously zoom in the image partially within the moving predetermined range 142.

Please refer to FIG. 5, when the touch screen 110 detects the disappear of at least one of the two objects 150, 152, for example, the object 152 leaves the touch screen 110, the partial image 132 is still zoomed in through a predetermined duration. Please refer to FIG. 6, when the pointer disappears, for example, both objects 150, 152 leave the touch screen 110, the partial image 132 is still zoomed in through a predetermined duration. In other words, when one or both of the objects 150, 152 disappear, the partial image 132 is still zoomed in so that a user could still click on the partial image 132.

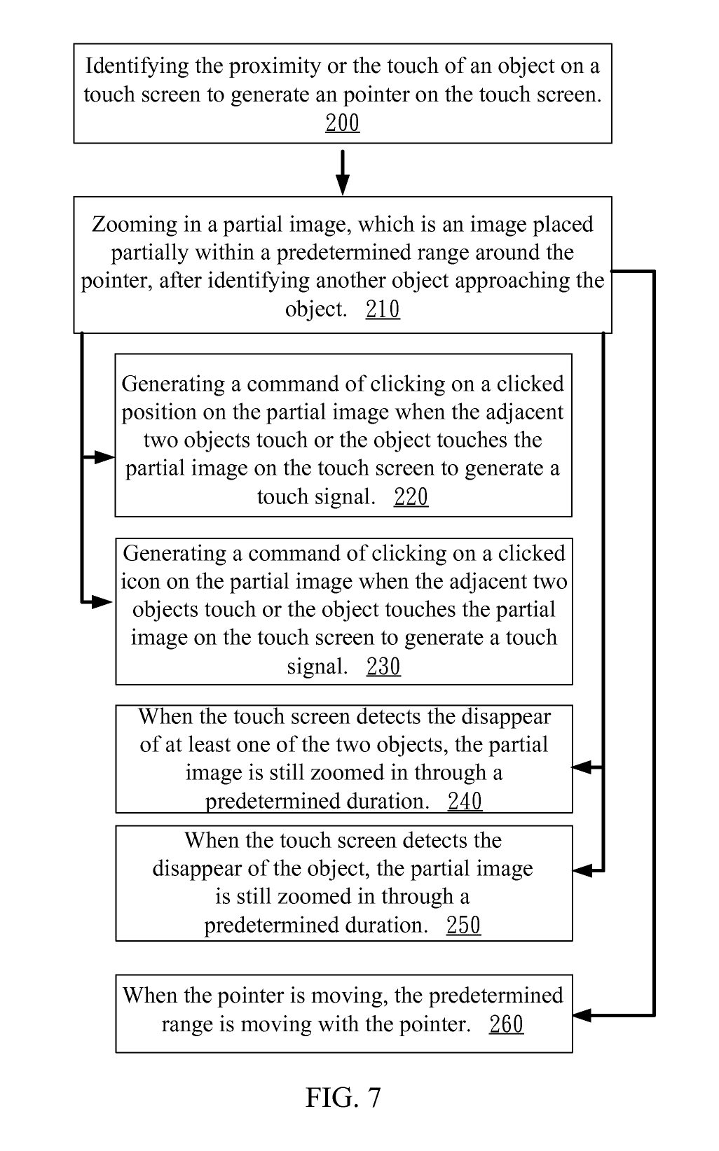

Accordingly, the present invention discloses a method for zooming in image, including the following steps. Please refer to FIG. 7, at first, in step 200, the proximity or the touch of an object on a touch screen is identified to generate a pointer on the touch screen. Next, in step 210, after identifying another object approaching the object, a partial image, which is an image placed partially within a predetermined range around the pointer, is zoomed in. While the adjacent two objects touch the touch screen to generate the touch signal, the object is located at the position of the wave crest of a touch signal. The center of the predetermined range is the position of the pointer, and the circumference of the predetermined range is formed by a predetermined radius.

Then, in step 220, when the adjacent two objects touch or the object touches the partial image on the touch screen to generate a touch signal, a command of clicking on a clicked position on the partial image is generated, wherein the clicked position on the partial image is mapping to a position on the image partially within the predetermined range.

Or, in step 230, when the adjacent two objects touch or the object touches the partial image on the touch screen to generate a touch signal, a command of clicking on a clicked icon on the partial image is generated, wherein the clicked icon on the partial image is mapping to an icon on the image partially within the predetermined range.

After step 210, when the touch screen detects the disappear of at least one of the two objects, the partial image is still zoomed in through a predetermined duration, as shown in step 240. Or, after step 210, when the touch screen detects the disappear of the object, the partial image is still zoomed in through a predetermined duration, as shown in step 250.

After step 210, when the pointer is moving, the predetermined range is moving with the pointer to simultaneously zoom in the image partially within the moving predetermined range, as shown in step 260.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An electronic device for zooming in image, comprising:
a touch screen, displaying an image and zooming in a partial image, which is the image placed partially within a predetermined range around a pointer; and
a processor, identifying the proximity or the touch of an object to generate the pointer on the touch screen, and controlling that the touch screen displays the partial image while identifying another one object approaching the object.

2. The electronic device of claim 1, wherein the object is placed at the position of the wave crest of a touch signal while the adjacent two objects touch the touch screen to generate the touch signal.

3. The electronic device of claim 1, wherein when the adjacent two objects touch or the object touches the partial image on the touch screen to generate a touch signal, the processor generates a command of clicking on a clicked position on the partial image, wherein the clicked position on the partial image is mapping to a position on the image partially within the predetermined range.

4. The electronic device of claim 1, wherein when the adjacent two objects touch or the object touches the partial image on the touch screen to generate a touch signal, the processor generates a command of clicking on a clicked icon on the partial image, wherein the clicked icon on the partial image is mapping to an icon on the image partially within the predetermined range.

5. The electronic device of claim 1, wherein when the touch screen detects the disappear of at least one of the two objects, the partial image is still zoomed in through a predetermined duration.

6. The electronic device of claim 1, wherein when the touch screen detects the disappear of the object, the partial image is still zoomed in through a predetermined duration.

7. The electronic device of claim 1, wherein the pointer is located at the center of the predetermined range, and the circumference of the predetermined range is formed by a predetermined radius.

8. The electronic device of claim 1, wherein when the pointer is moving, the predetermined range is moving with the pointer to simultaneously zoom in the image partially within the moving predetermined range.

9. A method for zooming in image, comprising:
identifying the proximity or the touch of an object on a touch screen to generate an pointer on the touch screen; and
zooming in a partial image, which is an image placed partially within a predetermined range around the pointer, after identifying another object approaching the object.

10. The method of claim 9, wherein the object is placed at the position of the wave crest of a touch signal while the adjacent two objects touch the touch screen to generate the touch signal.

11. The method of claim 9, further comprising the step of generating a command of clicking on a clicked position on the partial image when the adjacent two objects touch or the object touches the partial image on the touch screen to generate a touch signal, wherein the clicked position on the partial image is mapping to a position on the image partially within the predetermined range.

12. The method of claim 9, further comprising the step of generating a command of clicking on a clicked icon on the partial image when the adjacent two objects touch or the object touches the partial image on the touch screen to generate a touch signal, wherein the clicked icon on the partial image is mapping to an icon on the image partially within the predetermined range.

13. The method of claim 9, wherein when the touch screen detects the disappear of at least one of the two objects, the partial image is still zoomed in through a predetermined duration.

14. The method of claim 9, wherein when the touch screen detects the disappear of the object, the partial image is still zoomed in through a predetermined duration.

15. The method of claim 9, wherein the pointer is located at the center of the predetermined range, and the circumference of the predetermined range is formed by a predetermined radius.

16. The method of claim 9, wherein when the pointer is moving, the predetermined range is moving with the pointer to simultaneously zoom in the image partially within the moving predetermined range.
